(19) United States
(12) Patent Application Publication
(10) Pub. No.: US 2026/0122523 A1
(43) Pub. Date: Apr. 30, 2026

(54) UE MEASUREMENTS

(71) Applicant: Nokia Technologies Oy, Espoo (FI)

(72) Inventors: Jani-Pekka KAINULAINEN, Cambridge (GB); Riikka Karoliina DIMNIK, Espoo (FI); Lars DALSGAARD, Oulu (FI)

(21) Appl. No.: 19/149,136

(22) PCT Filed: Feb. 1, 2024
(86) PCT No.: PCT/EP2024/052533

§ 371 Date: Jul. 18, 2025

(30) Foreign Application Priority Data
Feb. 16, 2023 (GB) 2302223.9

(51) Int. Cl. H04W 24/10

(52) U.S. Cl. CPC H04W 24/10

(57) ABSTRACT

Examples of the disclosure relate to reporting availability of UE measurements. In examples of the disclosure a UE can be configured to receive a connection setup message and to enable transmission of a report wherein the report comprises an indication of measurement availability for one or more measurements performed by the UE and an indication of validation status for one or more measurements performed by the UE.

### TECHNOLOGICAL FIELD

Examples of the disclosure relate to User Equipment (UE) measurements. Some relate to reporting availability of UE measurements

### BACKGROUND

A UE is expected to perform measurements and validations of the measurements during procedures such as connection setup/connection resume. Any delays in the reporting of the measurements will result in delays in the set up of Carrier Aggregation (CA) or the set up Dual Connectivity or other procedure.

### BRIEF SUMMARY

According to various, but not necessarily all, examples of the disclosure there may be provided a User Equipment (UE) comprising means for:
receiving a connection setup message; and
enabling transmission of a report wherein the report comprises an indication of measurement availability for one or more measurements performed by the UE and an indication of validation status for one or more measurements performed by the UE.

The report may comprise an indication of one or more of:
measurements available
measurements not available
measurements ongoing (partially available)
validation not started
validation ongoing
validation completed
cell detected
index availability (available/not available)

The report may be transmitted in response to at least one of:
the received connection setup message;
an information request message.

The connection setup message may comprise at least one of:
an RRCSetup message;
an RRCResume message.

The report may be sent in an RRCSetupComplete message.

One or more of the measurements indicated in the report may comprise measurements for assisting at least one of:
set up of Carrier aggregation (CA);
set up of Dual Connectivity (DC).

One or more of the measurements indicated in the report may be performed by the UE during at least one of:
an idle mode or an inactive mode;
connection setup.

The means may also be for:
receiving an information request from the network; and
   enabling transmission of a further indication the of measurement availability and validation status for one or more measurements performed by the UE wherein the information request from the network is received after the network has waited for a specified time interval.

The means may also be for:
receiving an information request from the network wherein the information request comprises a request to provide measurement results; and
enabling transmission of a further indication of measurement availability and validation status for one or more measurements performed by the UE wherein the further indication comprises an indication of time needed to complete a validation process.

The information request may comprise a request for an indication of the measurement availability and validation status for one or more specified measurements.

The further indication of measurement availability and validation status may comprise an indication of the measurement availability and validation status for one or more specified measurements.

The means may also be for:
receiving an information request from the network; and
enabling transmission of a further indication the of measurement availability and validation status for one or more measurements performed by the UE wherein the further indication the of measurement availability and validation status is transmitted after the network has waited for a specified time interval.

According to various, but not necessarily all, examples of the disclosure there may be provided a method comprising:
receiving a connection setup message; and
enabling transmission of a report wherein the report comprises an indication of measurement availability for one or more measurements performed by the UE and an indication of validation status for one or more measurements performed by the UE.

According to various, but not necessarily all, examples of the disclosure there may be provided a computer program comprising instructions which, when executed by a UE, cause the UE to perform at least:
receiving a connection setup message; and
enabling transmission of a report wherein the report comprises an indication of measurement availability for one or more measurements performed by the UE and an indication of validation status for one or more measurements performed by the UE.

According to various, but not necessarily all, examples of the disclosure there may be provided a network entity comprising means for:
enabling transmission of a connection setup message to a UE; and
receiving a report wherein the resort comprises an indication of measurement availability for one or more measurements performed by the UE and an indication of validation status for one or more measurement performed by the UE.

According to various, but not necessarily all, examples of the disclosure there may be provided a method comprising
enabling transmission of a connection setup message to a UE; and
receiving a report wherein the resort comprises an indication of measurement availability for one or more measurements performed by the UE and an indication of validation status for one or more measurement performed by the UE.

According to various, but not necessarily all, examples of the disclosure there may be provided a computer program comprising instructions which, when executed by a network entity, cause the network entity to perform at least:
enabling transmission of a connection setup message to a UE; and
receiving a report wherein the resort comprises an indication of measurement availability for one or more measurements performed by the UE and an indication of validation status for one or more measurement performed by the UE.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

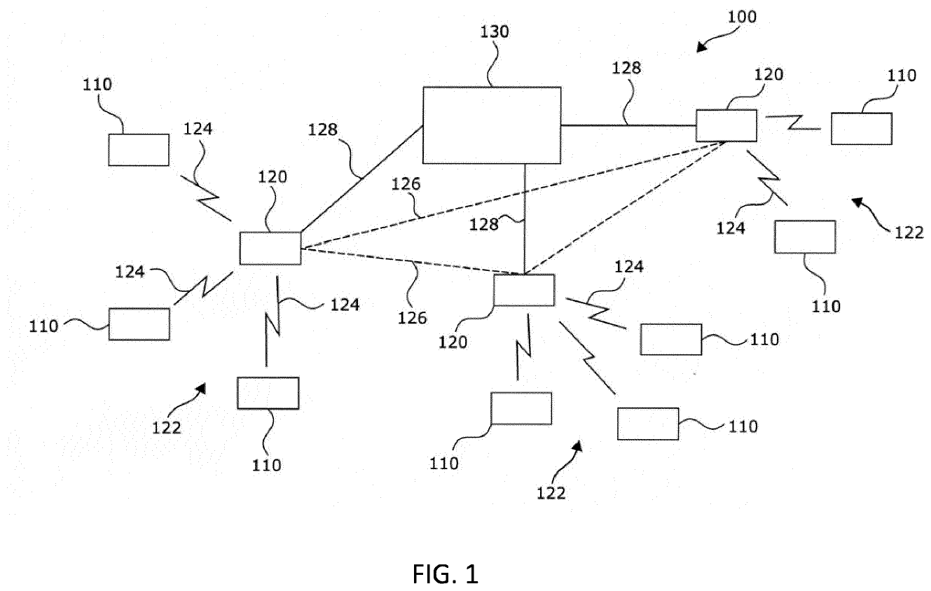

FIG. 1 shows an example network;

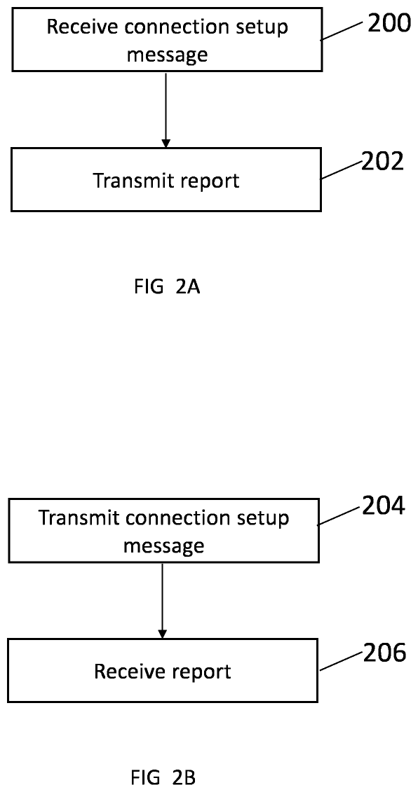

FIGS. 2A and 2B show example methods;

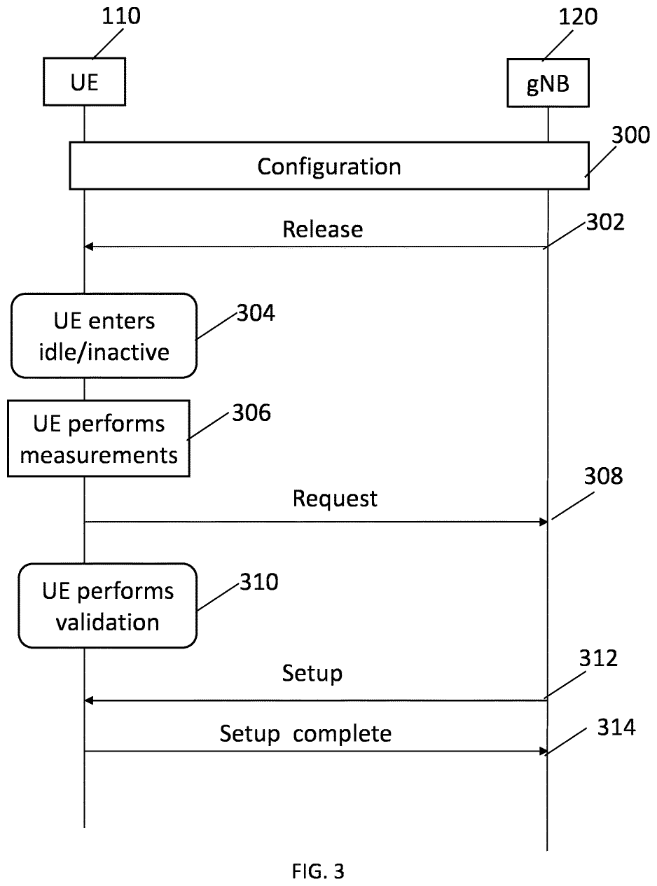

FIG. 3 shows another example method;

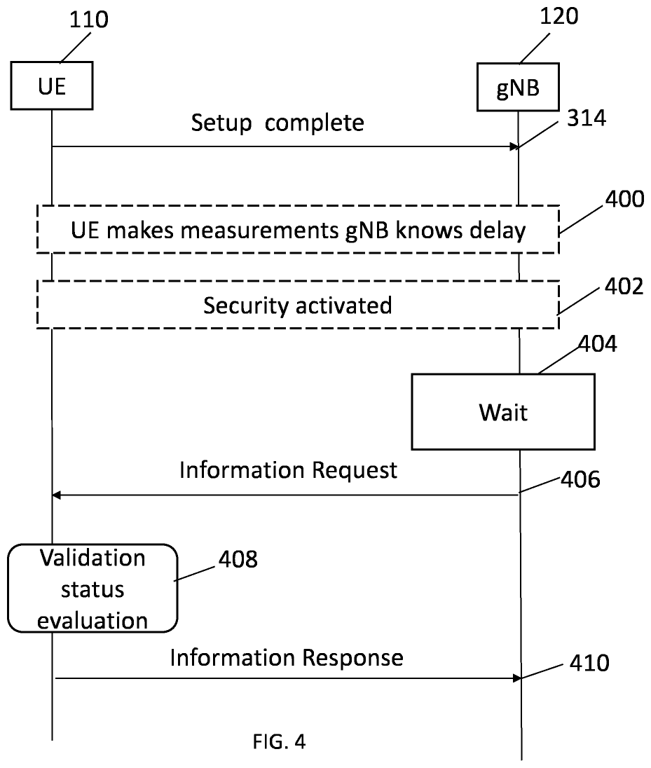

FIG. 4 shows another example method;

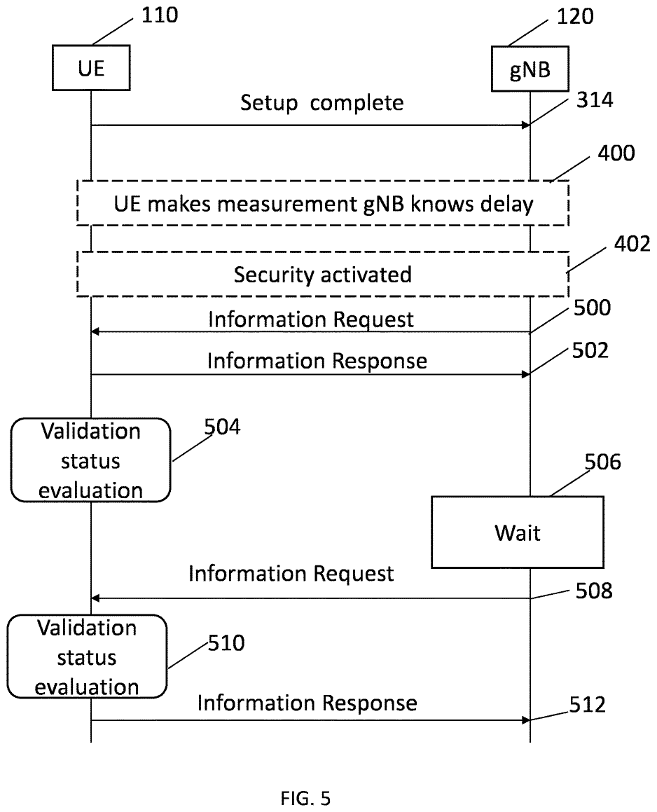

FIG. 5 shows another example method;

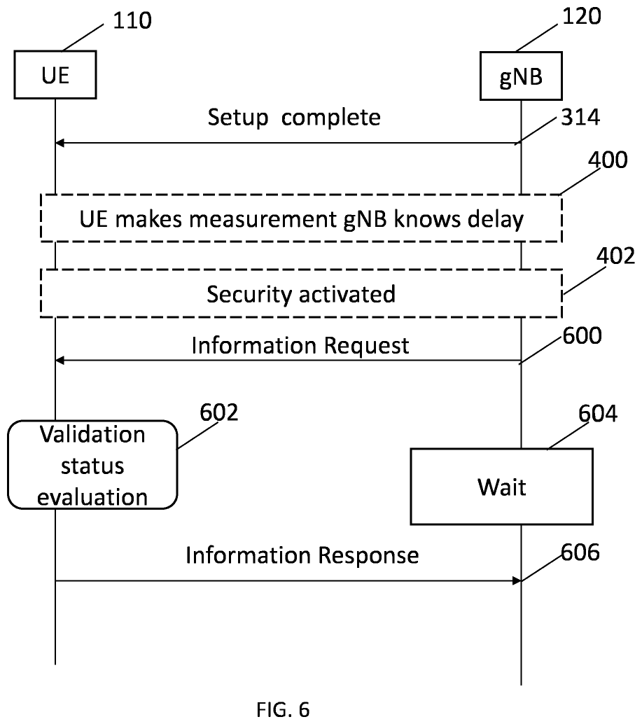

FIG. 6 shows another example method; and

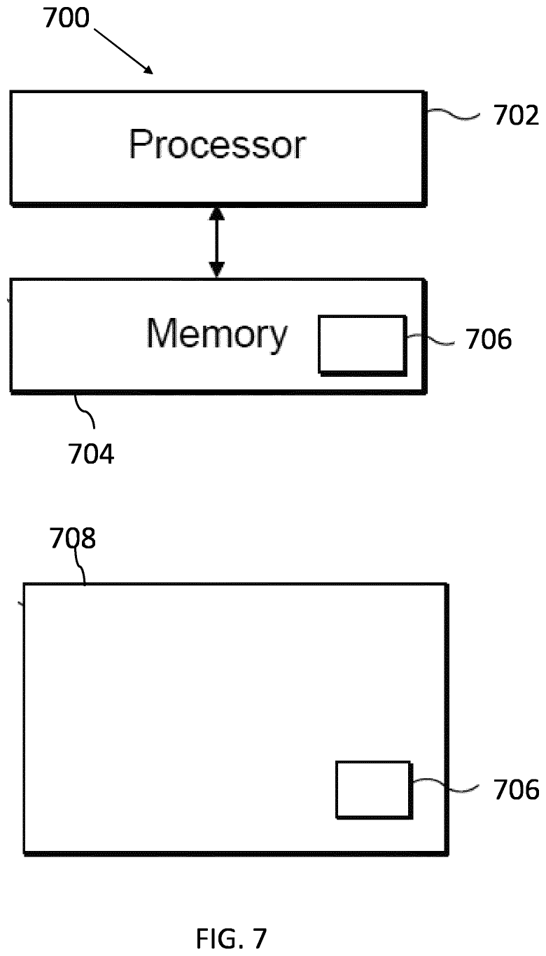

FIG. 7 shows an example controller.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### Definitions

AMF Access and Mobility Management Function
CA Carrier Aggregation
DC Dual Connectivity
E-UTRA Evolved Universal Mobile Telecommunications System (UMTS) Terrestrial Radio Access
eEMR Enhanced EMR
EMR Early Measurement Reporting
FR2 Frequency Range 2
gNB NR base station
IE Information Element
MO Mobile Originated
NR New Radio
O-RAN Open-Radio Access Network
RAN Radio Access Network
RRC Radio Resource Control
SCell Secondary Cell
SCG Secondary Cell Group
SIB System Information Block
SIM Subscriber Identity Module
SSB Synchronization Signal Block
UE User Equipment

### DETAILED DESCRIPTION

FIG. 1 illustrates an example of a network 100 comprising a plurality of network entities including terminal apparatus 110, node apparatus 120 and one or more network apparatus 130. The terminal apparatus 110 and node apparatus 120 communicate with each other. The one or more network apparatus 130 communicate with the access nodes 120. In some examples the one or more network apparatus 130 communicate with the terminal apparatus 110.

The one or more network apparatus 130 can, in some examples, communicate with each other. The one or more node apparatus 120 can, in some examples, communicate with each other.

The network 100 can be a cellular network comprising a plurality of cells 122 each served by a node apparatus 120. In this example, the interface between the terminal apparatus 110 and a node apparatus 120 defining a cell 122 is a wireless interface 124.

The node apparatus 120 comprises one or more cellular radio transceivers. The terminal apparatus 110 comprises one or more cellular radio transceivers.

In the example illustrated the cellular network 100 is a third generation Partnership Project (3GPP) network in which the terminal apparatus 110 are user equipment (UE) and the node apparatus 120 can be access nodes such as base stations.

The term ‘user equipment’ is used to designate mobile equipment comprising a smart card for authentication/encryption etc. such as a Subscriber Identity Module (SIM). In some examples the term ‘user equipment’ is used to designate mobile equipment comprising circuitry embedded as part of the user equipment for authentication/encryption such as software SIM.

The node apparatus 120 can be any suitable base station. A base station is an access node. It can be a network element responsible for radio transmission and reception in one or more cells to or from the UE 110. The node apparatus 120 can be a network element in a Radio Access Network (RAN), an Open-Radio Access Network (O-RAN), a E-UTRA (Evolved Universal Mobile Telecommunications System (UMTS) Terrestrial Radio Access) network, or any other suitable type of network.

The network apparatus 130 can be part of a core network. The network apparatus 130 can be configured to manage functions relating to connectivity for the UEs 110. For example, the network apparatus 130 can be configured to manage functions such as connectivity, mobility, authentication, authorization and/or other suitable functions. In some examples the network apparatus 130 can comprise an Access and Mobility management Function (AMF) or any other suitable entity.

In the example of FIG. 1 the network apparatus 130 is shown as a single entity. In some examples the network apparatus 130 could be distributed across a plurality of entities. For example, the network apparatus 130 could be cloud based or distributed in any other suitable manner.

The network 100 can be a 4G or 5G network, for example. It can for example be a New Radio (NR) network that uses gNB or eNB as access nodes 120. New Radio is the 3GPP name for 5G technology. In such cases the node apparatus 120 can comprise gNodeBs (gNBs) 120 configured to provide user plane and control plane protocol terminations towards the UE 110 and/or to perform any other suitable functions. The gNBs 120 are interconnected with each other by means of an X2/Xn interface 126. The gNBs are also connected by means of the N2 interface 128 to the network apparatus 130. The gNBs can be connected to an AMF or any other suitable network apparatus 130. Other types of networks and interfaces could be used in other examples. Other types of network could comprise next generation mobile and communication network, for example, a 6G network.

In networks 100 such as the network 100 of FIG. 1 when a connection is being set up or a connection is being resumed there is a benefit in having UE 110 measurements available early in connected mode. The benefit may be particularly relevant for a UE 110 transitioning from idle mode or inactive mode. For example, by decreasing the Frequency Range 2 (FR2) Secondary Cell/Secondary Cell Group (SCell/SCG) setup/resume delay for a UE 110 connecting from idle mode or inactive mode there is a significant positive impact on the user throughput. The reduced delay will also have a positive impact on UE 110 power saving. Examples of the disclosure therefore relate to enabling UE measurements to be available early in connected mode.

In NR networks 100 or other suitable networks early measurements can be configured in connection release messages that release a UE 110 to an idle or inactive mode. For example, the early measurements can be configured in an RRCRelease message or any other suitable type of message. In NR, and other suitable networks, both idle and inactive modes are supported for early measurements. For instance, a UE 110 can be configured to perform measurements until a given timer expires or is stopped. The timer could be T331 or any other suitable timer. This could be a mandatory part of the configuration which indicates for how long after release a UE 110 is required to perform early measurements. The measurements can then be used for assisting connected mode Carrier Aggregation (CA) and/or Dual Connectivity (DC) setup. The use of these measurements will limit the time taken to perform the measurements during CA and/or DC setup and can reduce power consumption of the UE 110.

The UE 110 can be configured to perform the measurements as indicated in the connection release message. The UE 110 does not need to perform measurements in an idle or inactive mode on a given carrier if the Synchronization Signal Block (SSB) configuration of that carrier provided via dedicated signaling is different from the SSB configuration broadcasted in the serving cell, if any.

If a UE 110 is not given carriers in the connection release message the UE 110 will measure carriers as listed in a suitable System Information Block (SIB) such as SIB11 (configuration for NR Cells in SIB5 in LTE). The UE 110 will perform the measurements in the idle or inactive mode only for the frequencies/carriers in the configured frequency list for which the UE 110 supports CA or DC between the frequency and the serving frequency/carrier.

Therefore, an Early Measurement Reporting (EMR) capable UE 110 can perform measurements in an idle mode or inactive mode until a timer such as T331 timer expires or is stopped. EMR UEs 110 can maintain the cells detectable from the connected mode until the timer expires or stopped. In the time interval between the expiry or stopping of the T331 timer the time that the UE 110 receives a connection setup or resume message it is unknown whether the cells are maintained. After the T331 timer expires, or is stopped it is dependent on UE 110 implementation whether the cells are maintained and detectable for early measurement reporting purposes. Based on UE 110 information indication and network information request the UE 110 can report the early measurement results after security is activated

FIGS. 2A and 2B show example methods according to examples of the disclosure. The methods enable reporting of early measurement results and also additional details relating to the measurements. The measurements can be measurements that are performed by the UE 110.

The measurements can comprise measurements that are performed by the UE 110 while the UE 110 is an idle mode or an inactive mode and/or measurements that are performed during connection setup and possibly during a period of time in connected mode. The measurements comprise measurements that are used for assisting setup of CA or setup of DC.

The method of FIG. 2A could be implemented by a UE 110 or an apparatus within a UE 110 or by any other suitable terminal entity.

A block 200 the method comprises receiving a connection setup message. The connection set up message can be received from a network entity such as a gNB 120. The connection setup message can comprise configuration information for the UE 110. The connection setup message can comprise a Radio Resource Control (RRC) setup message, an RRCResume message or any other suitable type of message. The connection setup procedure may also be based on mobile originated (MO) call and hence, initiated by the UE.

At block 202 the method comprises enabling transmission of a report. The report comprises an indication of measurement availability for one or more measurements performed by the UE 110 and an indication of validation status for one or measurements performed by the UE 110. The UE 110 can perform a validation process for the measurements it has performed or is performing. The validation process that is used will depend upon the type of measurements that have been made or are being made. The validation process can determine that the measurements results are still accurate or relevant or that the measurements satisfy one or more other appropriate criteria. For example, the validation process can determine if the measurements have been made during an appropriate time period or that they have obtained using an appropriate procedure.

The report can comprise any suitable information relating to the measurements performed by the UE 110. In some examples the response can comprise an indication of any one or more of: measurements available, measurements not available, measurements ongoing (partially available), validation not started, validation ongoing, validation completed, cell detected, index availability (available/not available), or any other suitable information.

The report can be transmitted in response to the received connection setup message. In some examples the report could be transmitted in response to a different message such as an information request message. The information request message could also be received from the network 100. The information request message could be received after the connection setup message has been received.

The report can be transmitted in any suitable message. In some examples the report can be sent in an RRCSetupComplete message. In some examples the response could be sent in a different message or could be sent in a new Information Element (IE). The different message could be a UEinformationresponse message or any other suitable message.

Further messages can be exchanged between the UE 110 and the network entity after the report has been transmitted or after the connection setup message is received.

For instance, in some examples the UE 110 can receive an information request. The information request can be received from the same network entity from which the original connection setup message was received. The information request can be received after the network has waited for a specified time interval. The time interval can be determined by the network or can be defined in a standard. The time interval can be determined based on an acceptable delay for the connection setup or connection resume procedure.

The information request can request further information relating to the measurement results. For example, the information request could request further information relating to a validity status and/or an availability status of the measurement results.

In response to receiving the information request the UE 110 can enable transmission of a further indication the of measurement availability and validation status for the measurements performed by the UE 110.

In some examples the UE 110 can receive an information request from the network where the information request comprises a request to provide measurement results. The information request can comprise a request for an indication of the measurement availability and validation status for one or more specified measurements. The measurements can be specified per cell, per carrier per SSB or per any other parameter.

In response to this request the UE 110 can enable transmission of a further indication of measurement availability and validation status for the measurements performed by the UE 110.

The further indication can comprise an indication of time needed to complete a validation process. The further indication of measurement availability comprises an indication of the measurement availability for one or more specified measurements as specified in the information request.

In some examples the UE 110 can receive an information request from the network. In response to receiving the information request the UE 110 can enable transmission of a further indication the of measurement availability and validation status for the measurements performed by the UE 110. The further indication the of measurement availability and validation status is transmitted after the network has waited for a specified time interval. The time interval can be determined by the network or can be defined in a standard. The time interval can be determined based on an acceptable delay for the connection setup or connection resume procedure.

The method of FIG. 2B could be implemented by a gNB 120 or an apparatus within a gNB 120 or other network entity.

The method comprises, at block 204, enabling transmission of a connection setup message to a UE 110. The connection setup message can comprise configuration information for the UE 110. The connection setup message can comprise an RRCSetup message, an RRCResume message or any other suitable type of message.

The method also comprises receiving at block 206, a report comprising an indication of measurement availability for one or more measurements performed by the UE 110. The report can comprise any suitable information relating to the measurements performed by the UE 110 as described herein.

In some examples the report can be received in response to the connection setup message. In some examples the report could be received in response to a different message. For example, the report could be received in response to an information request message. The information request message could be sent from the network entity to the UE 110. The information request can be sent after the connection setup message.

The report can be received from a UE 110. The report can be received from the UE 110 that the connection setup message was sent to. The report comprises an indication of measurement availability for one or more measurements performed by the UE 110. The report can comprise any suitable information relating to the measurements performed by the UE 110 as described herein.

FIG. 3 shows another example method that can be implemented using a UE 110 and gNB 120. The UE 110 and the gNB 120 can be part of a network as shown in FIG. 1 or could be part of any other suitable type of network 100.

At block 300 the UE 110 is configured with FR2 SCell and enhanced EMR (eEMR) capabilities. The eEMR capabilities enable the UE 110 to implement examples of the disclosure. However, the UE 110 can also implement examples of the disclosure without support of these capabilities.

At block 302 the gNB 120 transmits a release message to the UE 110. The release message can be an RRCRelease message or any other suitable type of message. The release message can release or suspend an RRCConnection so that the UE 110 can enter an idle mode or an inactive mode.

At block 304 the UE 110 enters the idle mode or the inactive mode. At block 306 the UE 110 performs measurements. The UE 110 performs measurements while in the idle mode or the inactive mode. The measurements can comprise any measurements that assist with the setup of carrier aggregation or dual connectivity.

At block 308 the UE 110 transmits a connection request message to the gNB 120. The connection request message can comprise an RRCRequest message or any other suitable type of message. The connection request message can comprise information such as UE 110 identity and establishment cause.

At block 310 the UE 110 performs validation of the measurements that have been performed or that are being performed. The validation process can be an ongoing process which may start before the UE 110 transmits a connection request message to the gNB 120 and can be ongoing during the connection setup.

The validation process can comprise an eEMR validation process, a validation process or any other suitable type of process. The process used for the validation can depend upon factors such as the type measurements that have been made and the connection scenario for the UE 110.

The time taken for the validation process is unknown because it can depend upon the circumstances. For example, it may take longer to perform validations on multiple channels than to perform validations on a single channel.

At block 312 the gNB 120 transmits a connection setup message to the UE 110. The measurements and the validation of the measurements can be ongoing when the UE 110 receives the connection setup message.

The connection setup message could be an RRCSetup message, an RRCResume message or any other suitable type of message.

When the UE 110 receives the connection setup message the UE 110 exits the idle mode or the inactive mode and makes a transition to a connected mode and sends the setup complete message at block 314. In examples of the disclosure the setup complete message can comprise a report. The report can comprise an indication of the availability of one or more measurements performed by the UE 110 and an indication of validation status for one or more measurements performed by the UE 110. The report can comprise one or more validated measurements performed by the UE 110.

The measurements being performed by the UE 110 and the validation of these measurements is ongoing during the connection setup. This is taken into account in the report. For instance, the report can indicate which measurements are completed and available, and which are ongoing and only partially available and which are not yet started and so are not yet available. Similarly, the report can indicate which measurements have been validated, which measurements have validation ongoing and which measurements have not yet start to be validated. For instance, the report might only include validated measurements.

In some examples additional messages can be exchanged between the UE 110 and the gNB 120 after the setup complete message has been transmitted. FIGS. 4 to 6 show different example methods that could be used in different implementations and use case scenarios.

FIG. 4 shows another example method that can be performed after the setup complete message has been transmitted at block 314. The setup complete message can comprise a report where the report comprises an indication of the availability of one or more measurements performed by the UE 110 and an indication of validation status for one or more measurements performed by the UE 110.

In the example of FIG. 4 the gNB 120 waits before requesting further information relating to the measurements.

In the method of FIG. 4, at block 400, the UE 110 continues to perform the measurements. The UE 110 can complete the measurements that were ongoing when the setup complete message was transmitted and/or can perform the measurements that had not been started when the setup complete message was transmitted.

The gNB 120, or any other suitable part of the network 100, can know the expected delay for the completion of the measurements. In some examples the delay could be determined in a standard. In some examples the delay can be determined based on an acceptable delay for establishing the connection. The delay could be a maximum allowed validation time. The delay could be defined in TS38.133 or in any other suitable standard or protocol.

At block 402 security is activated between the UE 110 and the gNB 120. Any suitable protocol can be used to activate the security. This block is optional. In some implementation this block can be omitted.

At block 404 the gNB 120 waits. The gNB 120 waits until the UE 110 is expected to have performed the measurements and the validation of the measurements or the validation process. The gNB 120 can wait for a time period that is determined based on the known delay, for example, the acceptable delay for establishing the connection. The gNB 120 might not send any requests for measurement results or measurement status or validation status during the waiting period. The UE 110 can continue to perform measurement and validation of the measurements during the waiting period.

At block 406 the gNB 120 sends an information request message to the UE 110. The information request message can be a UEInformationRequest message or any other suitable type of message.

In some examples the information request message can request specified measurements and/or the validation status for specified measurements. For example, the information request message can request the measurement results and/or the validation status per cell, per carrier, per SSB carrier or per any other suitable parameter.

At block 408 the UE 110 can perform, or continue to perform, an evaluation of the validation status of the measurements. For example, the UE 110 can perform eEMR validation status evaluation.

At block 410 the UE 110 responds to the information request message by sending an information response message to the gNB 120. The information response message can comprise a UEInformationResponse message or any other suitable type of message. The information response message can comprise the information that was requested in the information request message. The information response message can comprise the measurement results, the measurement status and a validation status for the measurements and any other suitable information. The measurement results, the measurement status and a validation status for the measurements can be provided for specified measurements as requested in the information request message. The measurement results, the measurement status and a validation status for the measurements can be provided per cell, per carrier, per SSB carrier or per any other suitable parameter. The measurement results can be provided only for validated measurement results.

FIG. 5 shows another example method that can be performed after the setup complete message has been transmitted at block 314. The setup complete message can comprise a report where the report comprises an indication of the availability of one or more measurements performed by the UE 110 and an indication of validation status for one or more measurements performed by the UE 110.

In the example of FIG. 5 the gNB 120 sends two requests for further information relating to the measurements.

In the method of FIG. 5, at block 400, the UE 110 continues to perform the measurements. The UE 110 can complete the measurements that were ongoing when the setup complete message was transmitted and/or can perform the measurements that had not been started when the setup complete message was transmitted. This can be as shown in FIG. 4 and described above.

The gNB 120, or any other suitable part of the network 100, can know the expected delay for the completion of the measurements. In some examples the delay could be determined in a standard. In some examples the delay can be determined based on an acceptable delay for establishing the connection. The gNB 120 can set a delay threshold. The delay threshold can be implementation specific. The delay could be a maximum allowed validation time. The delay could be defined in TS38.133 or in any other suitable standard or protocol. This can be as shown in FIG. 4 and as described above.

At block 402 security is activated between the UE 110 and the gNB 120. Any suitable protocol can be used to activate the security. This block is optional. In some implementation this block can be omitted. This can be as shown in FIG. 4 and as described above.

At block 500 the gNB 120 sends a first information request message to the UE 110. The first information request message can be a UEInformationRequest message or any other suitable type of message.

In some examples the first information request message can request specified measurements and/or the validation status for specified measurements. For example, the first information request message can request the measurement results and/or the validation status per cell, per carrier, per SSB carrier or per any other suitable parameter. In some examples the first information request message can request any messages that are ready or that meet a filter or criteria that has been indicated in the first information request message. For example, the first information request message can request measurements that have been completed and that have been validated.

In the example of FIG. 5 the gNB 120 sends the first information request message to the UE 110 without waiting for the UE 110 to complete the measurements and the validation of the measurements.

At block 502 the UE 110 responds to the first information request message by sending a first information response message to the gNB 120. The first information response message can comprise a UEInformationResponse message or any other suitable type of message. The first information response message can comprise the information that was requested in the first information request message. The first information response message can comprise the measurement results, the measurement status and a validation status for the measurements and any other suitable information. The measurement results, the measurement status and a validation status for the measurements can be provided for specified measurements as requested in the first information request message. The measurement results, the measurement status and a validation status for the measurements can be provided per cell, per carrier, per SSB carrier or per any other suitable parameter. For instance, the report may include only validated measurements.

In some examples the first information response message can comprise information relating to the measurements that were complete when the first information request message was sent. For example, the first information response message can comprise the measurement results for the measurements that were complete and validated when the first information request message was sent.

In some examples the first information response message can comprise an indication to the gNB 120 of how long the UE 110 needs to complete the measurements and the validation of the measurements. This information can then be used by the network 100 or the gNB 120 to determine when to send the second information request message.

At block 504 the UE 110 can perform, or continue to perform, an evaluation of the validation status of the measurements. For example, the UE 110 can perform eEMR validation status evaluation.

At block 506 the gNB 120 waits. The gNB 120 waits until the UE 110 is expected to have performed the measurements and the validation of the measurements. The gNB 120 can wait for a time period that is determined based on information provided in the first information response message. For example, the UE 110 can indicate the time needed to complete the measurements and the validation of the measurements in the first information response message and the gNB 120 can use this information to determine an appropriate waiting time.

At block 508 the gNB 120 sends a second information request message to the UE 110. The second information request message can be a UEInformationRequest message or any other suitable type of message.

In some examples the second information request message can request specified measurements and/or the validation status for specified measurements. For example, the second information request message can request the measurement results and/or the validation status per cell, per carrier, per SSB carrier or per any other suitable parameter. In some examples the second information request message can request different information to the information that was requested in the first information request message.

In the example of FIG. 5 the gNB 120 sends the second information request message after the gNB has waited for the UE 110 to complete the measurements and the validation of the measurements.

At block 510 the UE 110 can perform, or continue to perform, an evaluation of the validation status of the measurements. For example, the UE 110 can perform eEMR validation status evaluation. This can be a continuation of the process performed at block 504.

At block 512 the UE 110 responds to the second information request message by sending a second information response message to the gNB 120. The second information response message can comprise a UEInformationResponse message or any other suitable type of message. The second information response message can comprise the information that was requested in the second information request message. The second information response message can comprise the measurement results, the measurement status and a validation status for the measurements and any other suitable information. The measurement results, the measurement status and a validation status for the measurements can be provided for specified measurements as requested in the second information request message. The measurement results, the measurement status and a validation status for the measurements can be provided per cell, per carrier, per SSB carrier or per any other suitable parameter.

The second information response message can comprise different information to the first information response message. For example, the second information response message could comprise information relating to different measurements compared to the first information response. For instance, the first information response message could comprise information relating to measurements that were completed and validated when the first information request message was sent and the second information response message could comprise information relating to measurements that were completed when the second information request message was sent. For instance, the report might only include validated measurements.

Variations to this method could be used in some examples of the disclosure. For instance, in some examples, the UE 110 can start to transmit information response messages periodically (as measurements are done) until all the measurements are transmitted. In such cases the gNB 120 only has to send the first information request message and then the UE 110 will report an availability indication of the measurements periodically until UE 110 has the performed measurements and the validation process.

FIG. 6 shows another example method that can be performed after the setup complete message has been transmitted at block 314. The setup complete message can comprise a report where the report comprises an indication of the availability of one or more measurements performed by the UE 110 and an indication of validation status for one or more measurements performed by the UE 110.

In the example of FIG. 6 the UE 110 responds to a request for further information and validation of the measurements has been performed.

In the method of FIG. 6, at block 400, the UE 110 continues to perform the measurements. The UE 110 can complete the measurements that were ongoing when the setup complete message was transmitted and/or can perform the measurements that had not been started when the setup complete message was transmitted. This can be as shown in FIG. 4 and described above.

The gNB 120, or any other suitable part of the network 100, can know the expected delay for the completion of the measurements. In some examples the delay could be determined in a standard. In some examples the delay can be determined based on an acceptable delay for establishing the connection. The delay could be a maximum allowed validation time. The delay could be defined in TS38.133 or in any other suitable standard or protocol. This can be as shown in FIG. 4 and as described above.

At block 402 security is activated between the UE 110 and the gNB 120. Any suitable protocol can be used to activate the security. This block is optional. In some implementation this block can be omitted. This can be as shown in FIG. 4 and as described above.

At block 600 the gNB 120 sends an information request message to the UE 110. The information request message can be a UEInformationRequest message or any other suitable type of message.

In some examples the information request message can request specified measurements and/or the validation status for specified measurements. For example, the information request message can request the measurement results and/or the validation status per cell, per carrier, per SSB carrier or per any other suitable parameter. In some examples the information request message can request any messages that are ready. For example, the information request message can request measurements that have been completed and that have been validated.

In the example of FIG. 6 the gNB 120 sends the information request message to the UE 110 without waiting for the UE 110 to complete the measurements and the validation of the measurements.

At block 602 the UE 110 can perform, or continue to perform, an evaluation of the validation status of the measurements. For example, the UE 110 can perform eEMR validation status evaluation.

At block 604 the gNB 120 waits. The gNB 120 waits until the UE 110 is expected to have performed the measurements and the validation of the measurements. The gNB 120 can wait for a time period that is determined based on the known delay, for example, the acceptable delay for establishing the connection. The gNB 120 might not send any requests for measurement results or measurement status or validation status during the waiting period. The UE 110 can continue to perform measurement and validation of the measurements during the waiting period. In some examples the wait period is the time needed for the UE 110 to validate any available measurements.

At block 606 the UE 110 responds to the information request message by sending an information response message to the gNB 120. The information response message can comprise a UEInformationResponse message or any other suitable type of message. The information response message can comprise the information that was requested in the information request message. The information response message can comprise the measurement results, the measurement status and a validation status for the measurements and any other suitable information. The measurement results, the measurement status and a validation status for the measurements can be provided for specified measurements as requested in the information request message. The measurement results, the measurement status and a validation status for the measurements can be provided per cell, per carrier, per SSB carrier or per any other suitable parameter. In some examples the information response message might only include validated measurements.

Any suitable messages or information elements can be used to enable the UE 110 to indicate the measurement availability and the validation status of the measurements to the gNB 120. For example, the validation status could be indicated together with the measurement results. The following shows an example in which an idle mode reporting skeleton can be enhanced with additional information fields to indicate the validation status of the reported results.

This MeasResultIdleNR can be included in UEInformationResponse message and RRCResumeComplete message. This could be configured as follows:

### MeasResultIdleNR

The IE MeasResultIdleNR covers the NR measurement results performed in RRC_IDLE and RRC_INACTIVE.

MeasResultIdleNR information element

-- ASN1START
-- TAG-MEASRESULTIDLENR-START
MeasResultIdleNR-r16 ::= SEQUENCE {
measResultServingCell-r16 SEQUENCE {

| | |
|---|---|
| rsrp-Result-r16 | RSRP-Range |

OPTIONAL,

| | |
|---|---|
| rsrq-Result-r16 | RSRQ-Range |

OPTIONAL,

| | |
|---|---|
| resultsSSB-Indexes-r16 | ResultsPerSSB-IndexList-r16 |

```
OPTIONAL
  },
  measResultsPerCarrierListIdleNR-r16 SEQUENCE (SIZE (1.. maxFreqIdle-r16)) OF
```

| | |
|---|---|
| MeasResultsPerCarrierIdleNR-r16 | OPTIONAL, |

...
}

| | |
|---|---|
| MeasResultsPerCarrierIdleNR-r16 ::= | SEQUENCE { |
| carrierFreq-r16 | ARFCN-ValueNR, |
| measResultsPerCellListIdleNR-r16 | SEQUENCE (SIZE (1..maxCellMeasIdle-r16)) OF |

MeasResultsPerCellIdleNR-r16,
...
}

| | |
|---|---|
| MeasResultsPerCellIdleNR-r16 ::= | SEQUENCE { |
| physCellId-r16 | PhysCellId, |
| measIdleResultNR-r16 | SEQUENCE { |
| rsrp-Result-r16 | RSRP-Range |

OPTIONAL,

| | |
|---|---|
| rsrq-Result-r16 | RSRQ-Range |

OPTIONAL,

| | |
|---|---|
| resultsSSB-Indexes-r16 | ResultsPerSSB-IndexList-r16 |

OPTIONAL

| | |
|---|---|
| results-validition-status-r18 | ResultsValiditionStatus-r18 |

```
OPTIONAL
  },
  ...
}
```

| | |
|---|---|
| ResultsPerSSB-IndexList-r16 ::= | SEQUENCE (SIZE (1.. maxNrofIndexesToReport)) OF ResultsPerSSB- |

IndexIdle-r16

| | |
|---|---|
| ResultsPerSSB-IndexIdle-r16 ::= | SEQUENCE { |
| ssb-Index-r16 | SSB-Index, |
| ssb-Results-r16 | SEQUENCE { |
| ssb-RSRP-Result-r16 | RSRP-Range |

OPTIONAL,

| | |
|---|---|
| ssb-RSRQ-Result-r16 | RSRQ-Range |

OPTIONAL
}
OPTIONAL

| | |
|---|---|
| ResultsvalidationStatus-r18 ::= | SEQUENCE (SIZE (1.. maxNrofIndexesToReport)) OF ResultsPerSSB- |

IndexIdle-r16

| | |
|---|---|
| ResultsvalidationStatus-r18 ::= | SEQUENCE { |
| validation-Status-r18 | SEQUENCE { |
| Validation-r18 | [ MEASUREMENTS_AVAILABLE |
| | MEASUREMENTS_UNAVAILABLE |
| | MEASUREMENTS_ONGOING |
| | VALIDATION_COMPLETED |
| | VALIDATION_NOT_STARTED |
| | VALIDATION_ONGOING |
| | TARGET_NOT_DETECTED |
| | CELL_INDEX_NOT_ACQUIRED] |

OPTIONAL,
}
OPTIONAL
}
-- TAG-MEASRESULTIDLENR-STOP
-- ASN1STOP

Table 1 shows example fields descriptions for a MeasResultIdleNR Information element.

TABLE 1
MeasResultIdleNR field descriptions

carrierFreq
Indicates the NR carrier frequency.
measIdleResultNR
Idle/inactive measurement results for an NR cell (optionally including
beam level measurements).
measResultServingCell
Measured results of the serving cell (i.e., PCell) from idle/inactive
measurements.
measResultsPerCellListIdleNR
List of idle/inactive measured results for the maximum number of
reported best cells for a given NR carrier.
resultsSSB-Indexes
Beam level measurement results (indexes and optionally, beam
measurements).
results-validity-status
Status of the reported measurement results.

Table 2 shows example status messages that can be included in a report from the UE 110 to the gNB 120. These status messages could be included in an RRCSetupResume/Complete message or in response to UEInformationRequest or in any other suitable message.

TABLE 2

| | |
|---|---|
| Validation/availability status | Description |

These status messages can be included, for instance, in
RRCSetupResume/Complete or in a response to UEInformationRequest

| | |
|---|---|
| MEASUREMENTS_AVAILABLE | Indication that UE 110 has |
| | measurements available upon |
| | transmitting this report. |
| | Network 100 may request these |
| | measurements with |
| | UEInformationRequest. EMR |
| | UEs support this behaviour. |
| | eEMR UEs are required to |
| | support this indication when |
| | supporting eEMR capability. |
| MEASUREMENTS_UNAVAILABLE | Indication that no validated |
| | measurements are available. In |
| | case the network sends a UE |
| | information request to request |
| | measurements, the response will |
| | be empty. |
| MEASUREMENTS_ONGOING | Indicates UE110 is performing |
| | or is about to start performing |
| | measurements at the time of |
| | transmitting this indication. |
| | This means that UE measure- |
| | ment process for FR2 Scell |
| | is ongoing. Network may use |
| | UEInformationRequest to |
| | request measurements after a |
| | measurement delay has passed. |
| VALIDATION_COMPLETED | UE 110 has performed |
| | measurements and validated the |
| | results. Validated measurements |
| | are available immediately. |
| VALIDATION_NOT_STARTED | Indicates UE 110 has not started |
| | to validate measurements but |
| | will start to validate after |
| | transmitting this report. For |
| | instance, UE 110 transmits this |
| | indication. UE 110 will validate |
| | the measurements within valida- |
| | tion delay specified in TS |
| | 38.331 or any other suitable |
| | delay. |
| VALIDATION_ONGOING | Indicates that UE110 is |
| | performing validation after |
| | transmitting the availability |
| | indication. UE 110 will be |
| | performing validation measure- |
| | ments with validation delay |
| | less than full validation |
| | delay defined in TS 38.133 or |
| | any other suitable delay. |
| VALIDATION_NEEDED | Indicates that UE 110 is |
| | performing validation after |
| | transmitting the availability |
| | indication. UE 110 will be |
| | performing validation measure- |
| | ments with validation delay |
| | defined in TS 38.133 or any |
| | other suitable delay. |
| TARGET_NOT_DETECTED | Indicate that UE 110 has not |
| | detected the target cell |
| CELL_INDEX_NOT_ACQUIRED | Indicates that the cell index |
| | has not been acquired. Optional |
| | to UE 110 supporting index |
| | reading. |

The availability status and/or the validation status can be indicated for respective single measurements or could be indicated for multiple measurements. In some examples there might only be one availability status and this could be used to indicated the availability status and/or the validation status for multiple measurements. In such cases the gNB 120 or other network entity can be configured to:
1) Request information relating to availability and/or validation status of one measurement from the UE 110 in UE information request message or any other suitable message
2) If VALIDATION_COMPLETED, setup Scell directly to any of the associated cells
3) Request detailed validity information via UEInformationRequest and wait for UEInformationResponse before setting up Scell. Other messages could be used in other examples.

FIG. 7 illustrates an example of a controller 700. The controller 700 could be provided within an apparatus such as a UE 110 or a network apparatus. Implementation of a controller 700 may be as controller circuitry. The controller 700 may be implemented in hardware alone, have certain aspects in software including firmware alone or can be a combination of hardware and software (including firmware).

As illustrated in FIG. 7 the controller 700 can be implemented using instructions that enable hardware functionality, for example, by using executable instructions of a computer program 706 in a general-purpose or special-purpose processor 702 that may be stored on a computer readable storage medium (disk, memory etc.) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus when loaded into the processor 702. The computer program instructions, of the computer program 706, provide the logic and routines that enables the apparatus to perform the methods illustrated in the Figs. The processor 702 by reading the memory 704 is able to load and execute the computer program 706.

In examples where the controller 700 is provided within a UE 110 the controller 700 therefore comprises: at least one processor 702; and at least one memory 704 storing instructions that, when executed by the at least one processor 702, cause a UE 110 at least to perform:
receiving 200 a connection setup message; and
enabling transmission 202 of a report wherein the report comprises an indication of measurement availability for one or more measurements performed by the UE 110 and an indication of validation status for one or more measurements performed by the UE 110.

In examples where the controller 700 is provided within a gNB 120 the controller 700 therefore comprises: at least one processor 702; and at least one memory 704 storing instructions that, when executed by the at least one processor 702, cause a gNB 120 at least to perform
enabling transmission 204 of a connection setup message to a UE 110; and
receiving 206 a report wherein the resort comprises an indication of measurement availability for one or more measurements performed by the UE 110 and an indication of validation status for one or more measurement performed by the UE 110.

The computer program 706 may arrive at the UE 110 via any suitable delivery mechanism 708. The delivery mechanism 708 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 706. The delivery mechanism may be a signal configured to reliably transfer the computer program 706. The apparatus may propagate or transmit the computer program 706 as a computer data signal.

The computer program 706 can comprise computer program instructions for causing a UE 110 to perform at least the following or for performing at least the following:
receiving 200 a connection setup message; and
enabling transmission 202 of a report wherein the report comprises an indication of measurement availability for one or more measurements performed by the UE 110 and an indication of validation status for one or more measurements performed by the UE 110.

The computer program 706 can comprise computer program instructions for causing a gNB 120 to perform at least the following or for performing at least the following:
enabling transmission 204 of a connection setup message to a UE 110; and
receiving 206 a report wherein the resort comprises an indication of measurement availability for one or more measurements performed by the UE 110 and an indication of validation status for one or more measurement performed by the UE 110.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The stages illustrated in FIGS. 2 to 6 can represent steps in a method and/or sections of code in the computer program 706. The illustration of a particular order to the blocks does not necessarily imply that there is a required or preferred order for the blocks and the order and arrangement of the block may be varied. Furthermore, it can be possible for some blocks to be omitted.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A User Equipment (UE) comprising at least one processor; and at least one memory storing instructions that, when executed by the at least one processor, cause the UE at least to perform:
receiving a connection setup message;
enabling transmission of a report wherein the report comprises an indication of measurement availability for one or more measurements performed by the UE and an indication of validation status for one or more measurements performed by the UE;
receiving an information request from a network wherein the information request comprises a request to provide measurement results; and
enabling transmission of a further indication of the measurement availability and validation status for one or more measurements performed by the UE wherein the further indication comprises an indication of time needed to complete a validation process.

2. The UE as claimed in claim 1 wherein the report comprises an indication of one or more of:
measurements available;
measurements not available;
measurements ongoing (partially available);
validation not started;
validation ongoing;
validation completed;
cell detected;
index availability (available/not available).

3. The UE as claimed in claim 1 wherein the report is transmitted in response to at least one of:
the received connection setup message;
an information request message.

4. The UE as claimed in claim 3 wherein the connection setup message comprises at least one of:
an RRCSetup message;
an RRCResume message.

5. The UE as claimed in claim 4 wherein the report is sent in an RRCSetupComplete message.

6. The UE as claimed in claim 1 wherein one or more of the measurements indicated in the report comprise measurements for assisting at least one of:
set up of Carrier aggregation (CA);
set up of Dual Connectivity (DC).

7. The UE as claimed in claim 1 wherein one or more of the measurements indicated in the report are performed by the UE during at least one of:
an idle mode or an inactive mode;
connection setup.

8.-28. (canceled)
